(19) United States
(12) Patent Application Publication
(10) Pub. No.: US 2006/0238024 A1
(43) Pub. Date: Oct. 26, 2006

(54) Brake control apparatus and brake control method

(75) Inventor: Kumiko Akita, Nishikamo-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/386,794

(22) Filed: Mar. 23, 2006

(30) Foreign Application Priority Data
Apr. 21, 2005 (JP) 2005-123659

(51) Int. Cl. B60T 8/60

(52) U.S. Cl. 303/155

(57) ABSTRACT

A wheel cylinder receives operating fluid supplied from a master cylinder or an accumulator and operates a brake provided on each wheel of a vehicle. A valve control portion operates a master cutoff valve and a pressure increase valve in response to an operation of a brake pedal. When the brake pedal is operated, an operation timing instructing portion first instructs the valve control portion to operate the master cutoff valve. A voltage recovery characteristics measuring portion measures a voltage recovery time that it takes for the voltage of a power supply to recover to a predetermined level from a temporary drop due to operation of the master cutoff valve. Then after the voltage recovery time has passed after the master cutoff valve was operated, the operation timing instructing device instructs the valve control portion to operate the pressure increase valve.

### INCORPORATION BY REFERENCE

The disclosure of Japanese Patent Application No. 2005-123659 filed on Apr. 21, 2005 including the specification, drawings and abstract is incorporated herein by reference in its entirety.

### BACKGROUND OF THE INVENTION

1. Field of the Invention

The invention relates to a brake control apparatus and a brake control method. More particularly, the invention relates to a brake control apparatus that ensures operation of an electromagnetic valve even when there is a decrease in performance of a power supply in an electronically controlled brake system.

2. Description of the Related Art

A known electronically controlled brake system (hereinafter simply referred to as “ECB system”) is described in Japanese Patent Application Publication No. JP-A-2003-137082, for example. In this ECB system, when a brake pedal is operated by a driver of a vehicle, a required braking force requested by the driver is obtained based on signals output from a stroke sensor and a master cylinder pressure sensor, a target hydraulic pressure of a brake cylinder of each wheel of the vehicle is then obtained based on that required braking force, and hydraulic pressure is supplied from a high pressure source to the brake cylinder.

In this ECB system, a large amount of current is instantaneously consumed in order to simultaneously operate a plurality of control valves according to the required braking force. Accordingly, when the power supply voltage is extremely low, enough power to simultaneously operate the plurality of control valves may not be able to be supplied. As a result, the control valves may not be able to be operated as required.

### SUMMARY OF THE INVENTION

It is an object of this invention to provide brake control technology which ensures the operation of a control valve even when the power supply voltage is low.

A first aspect of the invention relates to a brake control apparatus. This apparatus includes: a master cylinder which supplies operating fluid in response to an operation of a brake pedal; an accumulator that stores high pressure operating fluid; a wheel cylinder at each wheel of a vehicle, which receives operating fluid supplied from the master cylinder or the accumulator and operates a brake provided at each wheel of the vehicle; a first communication path that connects the master cylinder with the wheel cylinder; a master cutoff valve provided midway in the first communication path; a second communication path that connects the accumulator with the wheel cylinder; a pressure increase valve provided midway in the second communication path; a power supply that supplies power to operate the master cutoff valve and the pressure increase valve; a valve control portion that controls the supply of power from the power supply such that the master cutoff valve and the pressure increase valve operate in response to an operation of the brake pedal; and a timing instructing portion that instructs the valve control portion to offset the timings at which the master cutoff valve and the pressure increase valve are operated.

According to this aspect of the invention, the timings at which the master cutoff valve and the pressure increase valve are operated are offset so that the valves are not operated at the same time. As a result, a large temporary drop in the power supply voltage can be avoided. Accordingly, operation of the master cutoff valve and the pressure increase valve can be ensured even if the power supply voltage falls below a minimum guarantee voltage for simultaneously operating the master cutoff valve and the pressure increase valve.

A second aspect of the invention relates to a brake control method. This method includes the steps of: supplying operating fluid with a master cylinder in response to an operation of a brake pedal; storing high pressure operating fluid with an accumulator; operating a wheel cylinder using the operating fluid supplied from the master cylinder or the accumulator so as to operate a brake provided in each wheel of a vehicle; and controlling the supply of power from a power supply so as to offset the timings at which a master cutoff valve provided midway in a communication path between the master cylinder and the wheel cylinder and a pressure increase valve provided midway in a communication path between the accumulator and the wheel cylinder are operated.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram showing the overall configuration of an ECU and a vehicle brake system according to one example embodiment of the invention;

FIG. 2 is a graph illustrating a change in battery voltage during operation of a master cutoff valve and a pressure increase valve;

FIG. 3 is a function block diagram showing the configuration of the ECU;

FIG. 4 is a flowchart of a routine for offsetting the timings at which the master cutoff valve and the pressure increase valve are operated;

FIG. 5 is a flowchart of a routine for measuring the voltage recovery time;

FIG. 6 is a flowchart of a routine for changing the gain; and

FIG. 7 is a flowchart of a routine for determining whether to operate a simulator cutoff valve when there is a request for braking.

### DETAILED DESCRIPTION OF THE PREFERRED EMBODIMENTS

First the overall configuration of an electronic control unit 200 (hereinafter, simply referred to as “ECU 200”) and a vehicle brake system 100 according to one example embodiment of the invention will be described. Following this, issues recognized by the inventor will be discussed, after which the detailed configuration of the apparatus will be described.

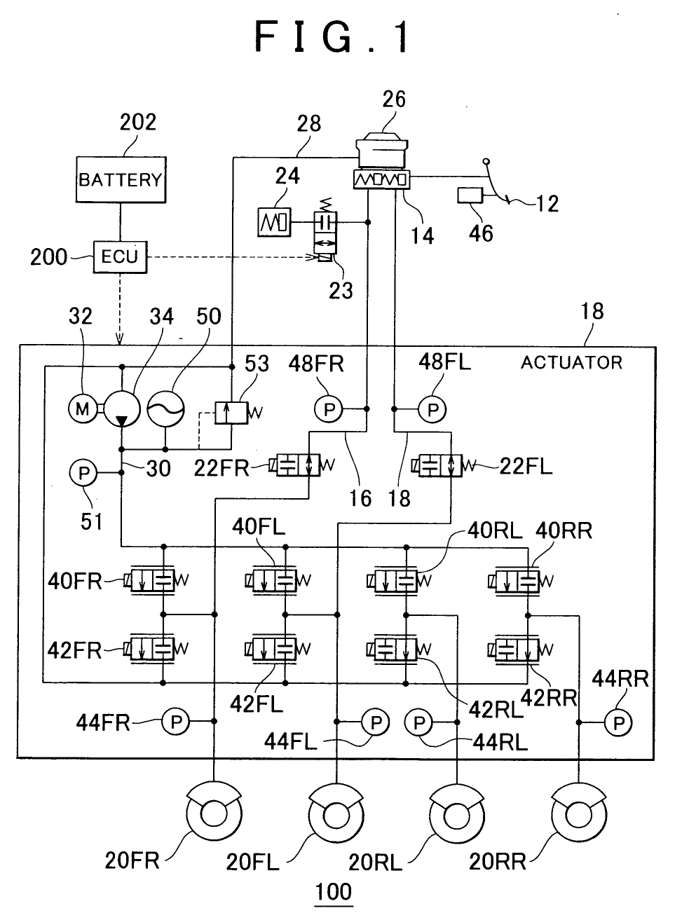

FIG. 1 shows the overall configuration of the vehicle brake system 100 and the ECU 200. The vehicle brake system 100 mainly includes an actuator 80. In addition to the actuator 80, the vehicle brake system 100 also includes a master cylinder 14 and the like. The vehicle brake system 100 is an ECB system which detects the operation amount of a brake pedal with a sensor, calculates the optimum brake pressure, and then operates the brakes individually for the four wheels.

A stroke sensor 46 is mounted on a brake pedal 12. This stroke sensor 46 detects a depression stroke of the brake pedal 12. The master cylinder 14 then sends brake oil, i.e., operating fluid, in response to the depression operation of the brake pedal 12 by the driver.

One end of a brake pressure control conduit 16 for the right front wheel is connected to the master cylinder 14, while the other end of the brake pressure control conduit 16 for the right front wheel is connected to a right-front-wheel wheel cylinder 20FR which generates braking force in the right front wheel. Similarly, one end of a brake pressure control conduit 18 for the left front wheel is connected to the master cylinder 14, while the other end of the brake pressure control conduit 18 for the left front wheel is connected to a left-front-wheel wheel cylinder 20FL which generates braking force in the left front wheel. A right master cutoff valve 22FR is provided midway in the brake pressure control conduit 16 for the right front wheel and a left master cutoff valve 22FL is provided midway in the brake pressure control conduit 18 for the left front wheel. These left and right master cutoff valves 22FL and 22FR are both electromagnetic valves which are open when de-energized and close when a brake operation is detected (thus these electromagnetic valves are referred to as “normally open valves”) (hereinafter these valves will be referred to as “master cutoff valve 22” when referred to collectively).

A right master pressure sensor 48FR which measures the master cylinder hydraulic pressure on the right front wheel is also provided midway in the brake pressure control conduit 16. Similarly, a left master pressure sensor 48FL which measures the master cylinder hydraulic pressure on the left front wheel is also provided midway in the brake pressure control conduit 18. When the driver depresses the brake pedal 12, the stroke sensor 46 detects the amount that the brake pedal 12 is depressed. Assuming that the stroke sensor 46 may fail, the force with which the brake pedal 12 is depressed is also detected by measuring the master cylinder hydraulic pressure with the left and right master pressure sensors 48FL and 48FR. Monitoring the master cylinder hydraulic pressure with two pressure sensors in this way serves as a kind of failsafe.

A reservoir tank 26 is connected to the master cylinder 14, as is a stroke simulator 24 which creates a reaction force and operating amount by the driver, via a simulator cutoff valve 23. This simulator cutoff valve 23 is a normally open electromagnetic valve that is open when de-energized and closes when the brake is operated. One end of a pressure supply and discharge conduit 28 is connected to the reservoir tank 26. An oil pump 34 which is driven by a motor 32 is provided in the pressure supply and discharge conduit 28. On the discharge side of the oil pump 34 is a high pressure conduit 30 in which is provided an accumulator 50 and a relief valve 53. The accumulator 50 stores brake oil that has been pressurized to within a range of 14 to 22 MPa, for example, by the oil pump 34 (hereinafter, this range will be referred to as the “control range”). The relief valve 53 opens when the accumulator pressure becomes abnormally high, e.g., 25 MPa, and releases the high pressure brake oil to the pressure supply and discharge conduit 28.

An accumulator pressure sensor 51 that measures accumulator pressure is provided in the high pressure conduit 30. A signal indicative of the accumulator pressure that is output from the accumulator pressure sensor 51 is input to the ECU 200, to be described later, and the ECU 200 controls the motor 32 so that the accumulator pressure falls within the control range.

The high pressure conduit 30 is connected to the right-front-wheel wheel cylinder 20FR, the left-front-wheel wheel cylinder 20FL, a right-rear-wheel wheel cylinder 20RR, and a left-rear-wheel wheel cylinder 20RL (hereinafter, these will collectively be referred to as “wheel cylinder 20”), via pressure increase valves 40FR, 40FL, 40RR, and 40RL, respectively, which are linear valves. These pressure increase valves are electromagnetic flow control valves which are closed when de-energized (i.e., these kinds of valves will hereinafter be referred to as a “normally closed valves”) and are used to increase the pressure in the wheel cylinders when necessary. Hereinafter the pressure increase valves 40FR, 40FL, 40RR, and 40RL will simply be referred to as “pressure increase valve 40” when referred to collectively.

Disc brakes are provided on the right front wheel, the left front wheel, the right rear wheel, and the left rear wheel of the vehicle. Braking force is generated by driving the wheel cylinders 20FR, 20FL, 20RR, and 20RL to push brake pads against the discs.

The right-front-wheel wheel cylinder 20FR and the left-front-wheel wheel cylinder 20FL are connected to the pressure supply and discharge conduit 28 via electromagnetic flow control valves used for decreasing the pressure when necessary, i.e., via normally closed pressure decrease valves 42FR and 42FL, respectively, which are linear valves. Further, the right-rear-wheel wheel cylinder 20RR is connected to the pressure supply and discharge conduit 28 via a normally open pressure decrease valve 42RR and the left-rear-wheel wheel cylinder 20RL is connected to the pressure supply and discharge conduit 28 via a normally open pressure decrease valve 42RL. Hereinafter, the pressure decrease valves 42FR, 42FL, 42RR, and 42RL will simply be referred to as “pressure decrease valve 42” when referred to collectively.

A right front wheel pressure sensor 44FR is provided near the right-front-wheel wheel cylinder 20FR, a left front wheel pressure sensor 44FL is provided near the left-front-wheel wheel cylinder 20FL, a right rear wheel pressure sensor 44RR is provided near the right-rear-wheel wheel cylinder 20RR, and a left rear wheel pressure sensor 44RL is provided near the left-rear-wheel wheel cylinder 20RL. These pressure sensors measure the hydraulic pressure within the wheel cylinders.

The ECU 200 controls the master cutoff valves 22FR and 22FL, the simulator cutoff valve 23, the motor 32, the four pressure increase valves 40FR, 40FL, 40RR, and 40RL, and the four pressure decrease valves 42FR, 42FL, 42RR, and 42RL. The ECU 200 includes a computing unit made up of a microcomputer, ROM in which various control programs are stored, and RAM which is used as a work area for storing data and executing programs, and the like.

The ECU 200 receives a signal indicative of the internal pressure of the right-front-wheel wheel cylinder 20FR from the pressure sensor 44FR of the right front wheel, a signal indicative of the internal pressure of the left-front-wheel wheel cylinder 20FL from the pressure sensor 44FL of the left front wheel, a signal indicative of the internal pressure of the right-rear-wheel wheel cylinder 20RR from the pressure sensor 44RR of the right rear wheel, and a signal indicative of the internal pressure of the left-rear-wheel wheel cylinder 20RL from the pressure sensor 44RL of the left rear wheel (hereinafter, these signals will collectively be referred to as “wheel cylinder hydraulic pressure signal”). The ECU 200 also receives other signals such as a signal indicative of a depression stroke of the brake pedal 12 (hereinafter this signal will be referred to as “stroke signal”) from the stroke sensor 46, signals indicative of a master cylinder hydraulic pressure (hereinafter these signals will be referred to as “master cylinder hydraulic pressure signals”) from the right master pressure sensor 48FR and the left master pressure sensor 48FL, and a signal indicative of an accumulator pressure (hereinafter this signal will be referred to as “accumulator pressure signal”) from the accumulator pressure sensor 51.

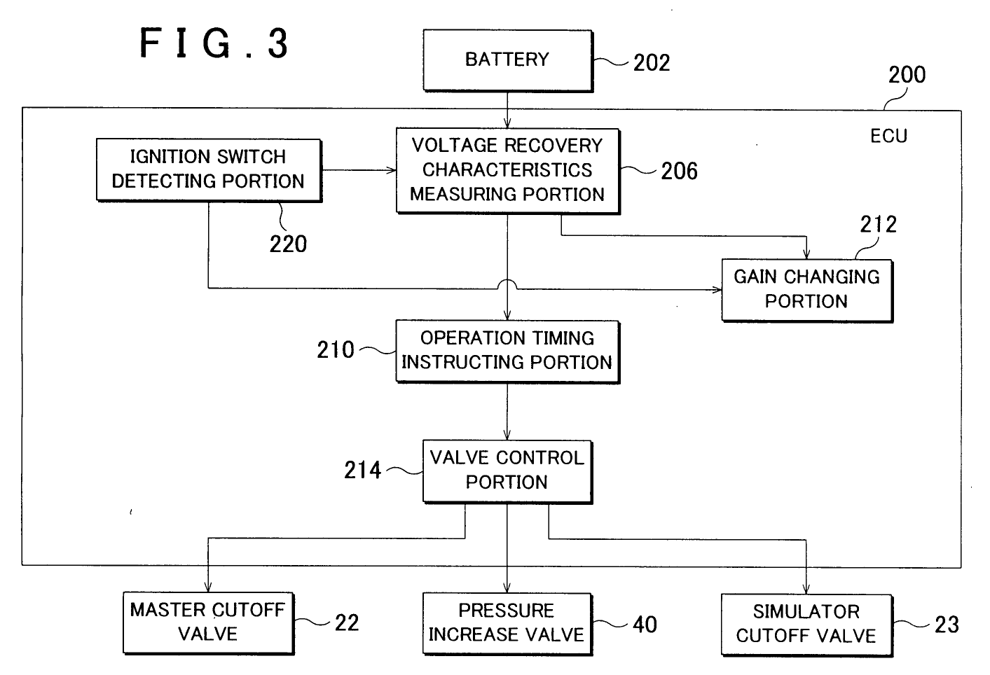

A predetermined brake control flow is stored in the ROM of the ECU 200. A valve control portion (see FIG. 3) in the ECU 200 first calculates a target deceleration rate for the vehicle based on the stroke signal and the master cylinder hydraulic pressure signals, then calculates a target wheel cylinder hydraulic pressure for each wheel based on that calculated target deceleration rate, and controls the pressure increase valve 40 and the pressure decrease valve 42 so that the wheel cylinder hydraulic pressure of each wheel comes to match the target wheel cylinder hydraulic pressure.

The oil pump 34 driven by the motor 32 draws up brake oil through the hydraulic pressure supply and discharge conduit 28 and stores the high pressure brake oil in the accumulator 50. The high pressure brake oil in the accumulator 50 is then supplied to each wheel cylinder 20 by opening/closing the pressure increase valve 40 according to the target wheel cylinder hydraulic pressure.

When the brake pedal 12 is depressed and the high pressure brake oil from the accumulator 50 consumed, the ECU 200 operates the motor 32 to drive the oil pump and store more high pressure brake oil in the accumulator 50 so that the pressure in the accumulator 50 always remains within the control range. This operation is referred to as an “accumulation operation” and is automatically performed according to a detection value of the accumulator pressure sensor 51.

The battery 202 supplies power to operate the master cutoff valve 22, the simulator cutoff valve 23, the pressure increase valve 40, and the pressure decrease valve 42. The reaction speed and opening amount of the electromagnetic valves can be changed by controlling the current value supplied from the battery 202 to the electromagnetic valves. The rated voltage of the battery 202 is, for example, 12 V.

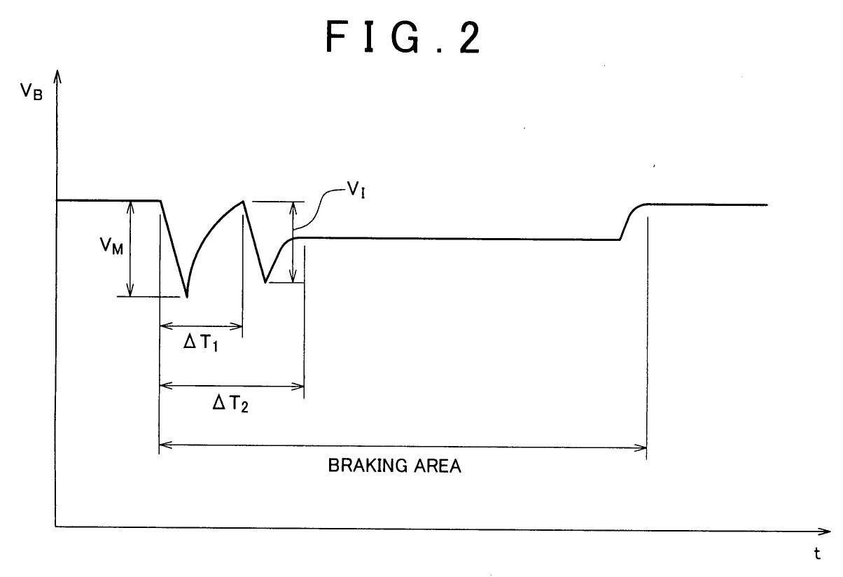

FIG. 2 is a graph showing the change in battery voltage when the master cutoff valve and the pressure increase valve are operated. In the drawing, “V_{M}” denotes the amount of drop in battery voltage due to operating the master cutoff valve, and “V₁” denotes the amount of drop in battery voltage due to operating the pressure increase valve. During normal operation, the battery voltage is set so that there is sufficient voltage to operate both the master cutoff valve and the pressure increase valve simultaneously. When the battery is used for an extended period of time, however, it deteriorates and the maximum voltage decreases. As a result, the voltage may fall below the minimum voltage guaranteeing simultaneous operation of the master cutoff valve and the pressure increase valve. If the battery voltage falls below this minimum guarantee voltage and the master cutoff valve is unable to close when a stroke signal is detected, operating fluid from the accumulator will flow into the master cylinder and the pressure from this operating fluid will be detected by the master cylinder pressure sensor. As a result, braking as intended by the driver may be unable to be obtained.

Therefore, in this example embodiment, when controlling electromagnetic valves in response to a detected stroke signal and master cylinder hydraulic pressure signal, normal operation of the master cutoff valve is ensured even when the battery voltage is low, by offsetting the timings at which the master cutoff valve and the pressure increase valve are operated so that they are not operated at the same time.

FIG. 3 is a function block diagram mainly showing the configuration of the portions in the ECU 200 which execute the control that ensures operation of the master cutoff valve. Each block in this diagram is able to be realized in terms of hardware by elements including a computer CPU and memory, and in terms of software by computer programs and the like. Here they are illustrated as function blocks that are realized by the coordinated operation of the two. Thus, those skilled in the art will understand that these function blocks can be realized in various forms by the combination of hardware and software.

A voltage recovery characteristics measuring portion 206 measures the voltage recovery characteristics of the battery 202. These voltage recovery characteristics include the amount that the battery voltage temporarily drops when an electromagnetic valve such as the master cutoff valve is operated, and the voltage recovery time which is the time required for the battery voltage to recover to a predetermined level following a voltage drop. The voltage recovery characteristics measuring portion 206 measures both a voltage recovery time ΔT₁ (see FIG. 2) which is the time required for the voltage of the battery 202 to recover to a predetermined voltage (such as 12 V) after the master cutoff valve 22 is operated, and a voltage recovery time ΔT₂ (see FIG. 2) which is the time required for the voltage of the battery 202 to recover to a predetermined voltage (such as 10 V) after the master cutoff valve 22 and the pressure increase valve 40 are operated in succession. The voltage recovery characteristics of the battery 202 may either be measured each time the ignition switch of the vehicle is turned on or at the time of shipping. When it is measured at the time of shipping, the voltage recovery characteristics measuring portion 206 may retain a table for correcting the voltage recovery time measured taking into account the effects from deterioration over time of the battery 202. This table is created in advance through experimentation.

An operation timing instructing portion 210 instructs the valve control portion 214 as to the timings at which the master cutoff valve 22 and the pressure increase valve 40 are to be operated. More specifically, the operation timing instructing portion 210 first outputs an instruction to operate the master cutoff valve 22, and then after the voltage recovery time ΔT₁ has passed, outputs an instruction to operate the pressure increase valve 40. The operation timing instructing portion 210 also determines whether to operate the simulator cutoff valve 23 depending on the voltage recovery characteristics.

An ignition switch detecting portion 220 detects when the ignition switch has been turned on by the driver of the vehicle, and transmits that information to the voltage recovery characteristics measuring portion 206 and a gain changing portion 212.

The gain changing portion 212 changes the control gain of the pressure increase valve 40 based on the voltage recovery characteristics measured by the voltage recovery characteristics measuring portion 206. The gain changing portion 212 may also count the number of times that the ignition has been detected on by the ignition switch detecting portion 220 and change the control gain in response to that number of times.

The valve control portion 214 calculates a target deceleration rate of the vehicle based on the stroke signal and the master cylinder hydraulic pressure signals, and then calculates a target wheel cylinder hydraulic pressure for each wheel based on the calculated target deceleration rate, and opens/closes the master cutoff valve 22, the pressure increase valve 40, the pressure decrease valve 42, and the simulator cutoff valve 23 so that the wheel cylinder hydraulic pressure of each wheel comes to match the target wheel cylinder hydraulic pressure. The valve control portion 214 also receives instructions from the operation timing instructing portion 210 according to which it then controls the master cutoff valve 22, the pressure increase valve 40, and the simulator cutoff valve 23.

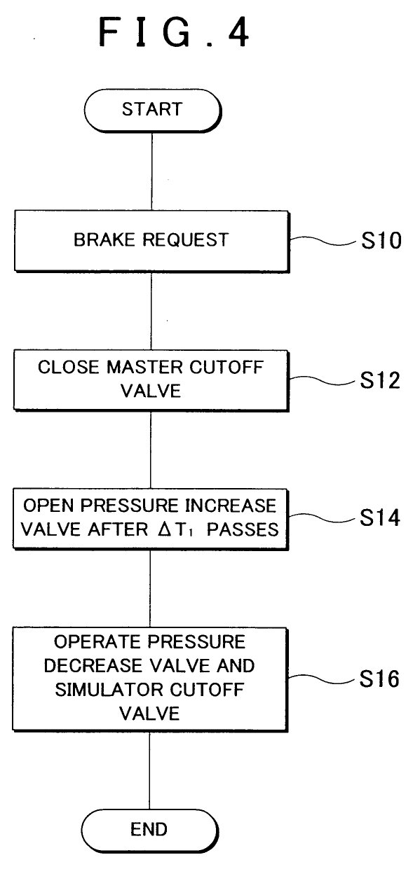

FIG. 4 is a flowchart of a process for offsetting the operation timing of the master cutoff valve and the pressure increase valve. When a brake request is issued according to a stroke signal and a master cylinder hydraulic pressure signal (S10), the operation timing instructing portion 210 instructs the valve control portion 214 to close the master cutoff valve 22 (S12). Then when the voltage recovery time ΔT₁, measured by the voltage recovery characteristics measuring portion 206 has passed, the operation timing instructing portion 210 instructs the valve control portion 214 to open the pressure increase valve 40 (S14). Thereafter, the valve control portion 214 controls the pressure decrease valve 42 and the simulator cutoff valve 23 as usual (S16).

In this manner, when a brake request is issued, the master cutoff valve is operated first and then the pressure increase valve is operated after the battery voltage has recovered from the drop that occurred from operating the master cutoff valve. As a result, operation of the master cutoff valve can be ensured even if the battery voltage falls below the minimum operating guarantee voltage for simultaneously operating the master cutoff valve and the pressure increase valve.

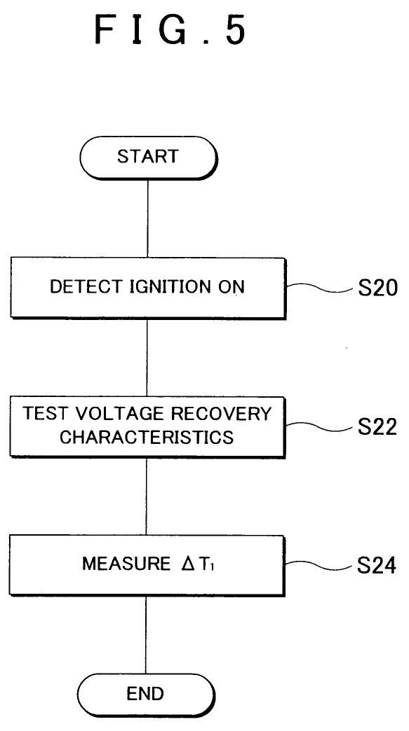

FIG. 5 is a flowchart illustrating a routine for measuring the voltage recovery time. When the ignition switch detecting portion 220 detects that the ignition switch has been turned on (S20), a test of the voltage recovery characteristics of the battery 202 starts (S22). The valve control portion 214 operates the master cutoff valve 22 irrespective of whether there is a brake request, and the voltage recovery characteristics measuring portion 206 measures both the amount of voltage drop in the battery 202 at that time and the voltage recovery time ΔT₁ (S24).

Measuring the voltage recovery characteristics every time the ignition is turned on in this way enables the offset timing of the master cutoff valve and the pressure increase valve to be set appropriately even when, for example, deterioration of the battery has progressed due to usage in an environment that was unforeseeable at the time of shipping. When operation of the master cutoff valve is ensured by using a backup battery, not shown, the test is performed after switching from the battery 202 to the backup battery when measuring the voltage recovery characteristics. The operation timing instructing portion 210 may also be configured so as not to execute the routine for offsetting the operation timing of the master cutoff valve and the pressure increase valve when the battery voltage measured by the voltage recovery characteristics measuring portion 206 is at a sufficient level.

Instead of measuring the voltage recovery time ΔT₁ every time the ignition is turned on, the voltage recovery time ΔT₁ may be measured at the time of shipping, and thereafter a voltage recovery time that matches the deterioration over time in the battery performance that was measured in advance may be applied. This method is inferior to the method illustrated in FIG. 5 in terms of accuracy, but is preferable in the sense that it extends the life of the battery by an amount equivalent to the amount of loss of battery power that it takes to check the voltage recovery characteristics. This method is also less costly because there is no need to provide a separate circuit for checking the voltage characteristics. The correction amount of the voltage recovery time from the deterioration over time in the battery performance can be estimated from the running distance of the vehicle, the number of times the ignition has been turned on, and the operating time of the battery.

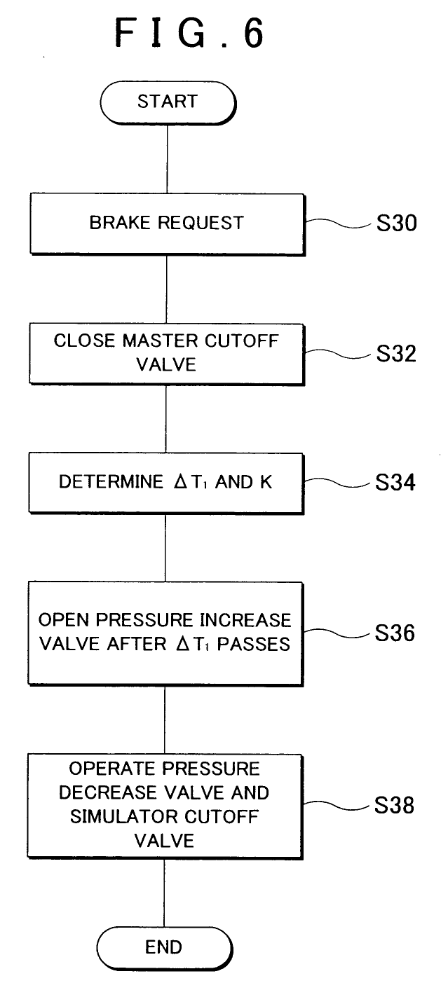

FIG. 6 is a flowchart illustrating a routine for changing the gain of the pressure increase valve. When a brake request is issued according to a stroke signal and a master cylinder hydraulic pressure signal (S30), the operation timing instructing portion 210 instructs the valve control portion 214 to close the master cutoff valve 22 (S32). The operation timing instructing portion 210 then estimates the voltage recovery time ΔT₁ measured by the voltage recovery characteristics measuring portion 206 and a gain K of the pressure increase valve either by referencing a table prepared in advance or by using a predetermined estimating method (S34). This table is created in advance through experimentation. After the voltage recovery time ΔT₁ has passed, the operation timing instructing portion 210 then instructs the valve control portion 214 to open the pressure increase valve 40 after the control gain has been changed to K (S36). Then the valve control portion 214 controls the pressure decrease valve 42 and the simulator cutoff valve 23 as usual (S38).

If the timing at which the pressure increase valve is opened is too late due to operation of the master cutoff valve first, the driver may feel a delay in the brake response. Therefore, when control is performed to ensure operation of the master cutoff valve, the gain of the control current of the pressure increase valve is changed (i.e., increased) to the optimum value according to the delay time of the pressure increase valve or the battery voltage recovery characteristics so that the response delay of the pressure increase valve is reduced.

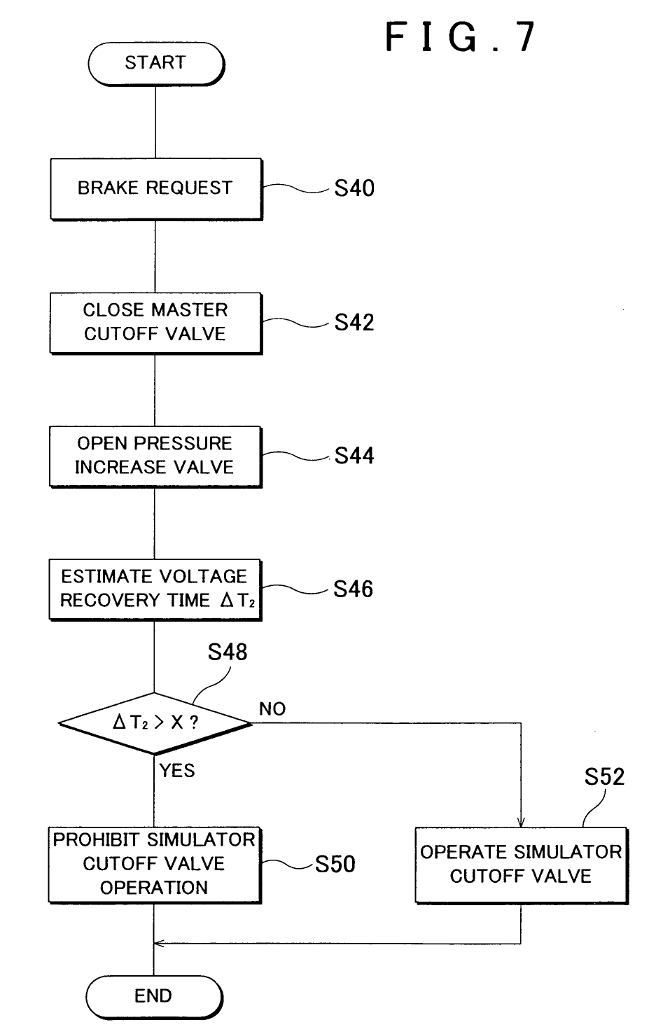

FIG. 7 is a flowchart illustrating a routine for determining whether to operate the simulator cutoff valve when there is a brake request. When a brake request is issued according to a stroke signal and a master cylinder hydraulic pressure signal (S40), the operation timing instructing portion 210 first instructs the valve control portion 214 to close the master cutoff valve 22 (S42). Then when the voltage recovery time ΔT₁ measured by the voltage recovery characteristics measuring portion 206 has passed, the operation timing instructing portion 210 instructs the valve control portion 214 to open the pressure increase valve 40 (S44).

The voltage recovery characteristics measuring portion 206 estimates a second voltage recovery time ΔT₂ that it takes for the voltage of a power supply which has temporarily dropped due to operating the master cutoff valve 22 and the pressure increase valve 40 to recover to a predetermined voltage (S46). This estimation may be according to a calculation formula prepared in advance based on the size of the ΔT₁, or the voltage recovery time may be measured during the voltage recovery characteristics test every time the ignition is turned on.

Continuing on, the operation timing instructing portion 210 determines whether the second voltage recovery time ΔT₂ is equal to or greater than a predetermined threshold value X (S48). If the second voltage recovery time ΔT₂ is equal to or greater than the predetermined threshold value X (i.e., Y in S48), then operation of the simulator cutoff valve stops (S50). If the second voltage recovery time ΔT₂ is less than the predetermined threshold value X (i.e., N in S48), the simulator cutoff valve is operated as usual (S52).

While the stroke simulator is important for giving the driver a sense of security, generating the appropriate braking force is even more important. Therefore, when it takes time for the power supply voltage that has dropped following operation of the master cutoff valve and the pressure increase valve to recover, the drop in the battery voltage is kept to a minimum by not operating the simulator cutoff valve.

Although the invention has been described herein with reference to specific embodiments, many modifications and variations therein are possible with respect to combinations of the various structural elements and processes. Accordingly, it is understood by those skilled in the art that all such variations and modifications are included within the intended scope of the invention.

What is claimed is:

1. A brake control apparatus comprising:
a master cylinder which supplies operating fluid in response to an operation of a brake pedal;
an accumulator that stores high pressure operating fluid;
a wheel cylinder at each wheel of a vehicle, which operates a brake provided at each wheel of the vehicle using the operating fluid supplied from the master cylinder or the accumulator;
a first communication path that connects the master cylinder with the wheel cylinder;
a master cutoff valve provided midway in the first communication path;
a second communication path that connects the accumulator with the wheel cylinder;
a pressure increase valve provided midway in the second communication path;
a power supply that supplies power to operate the master cutoff valve and the pressure increase valve;
a valve control portion that controls the supply of power from the power supply such that the master cutoff valve and the pressure increase valve operate in response to an operation of the brake pedal; and
a timing instructing portion that instructs the valve control portion to offset the timings at which the master cutoff valve and the pressure increase valve are operated.

2. The brake control apparatus according to claim 1, further comprising:
a voltage measuring portion that measures a first voltage recovery time that it takes for the voltage of the power supply to recover to a first predetermined level from a temporary drop due to operation of the master cutoff valve, wherein:
the valve control portion operates the master cutoff valve when the brake pedal is operated; and
the timing instructing portion instructs the valve control portion to operate the pressure increase valve after the first voltage recovery time has passed after the master cutoff valve was operated.

3. The brake control apparatus according to claim 2, wherein the first voltage recovery time is corrected based on deterioration over time of the power supply.

4. The brake control apparatus according to claim 2, further comprising a gain changing portion which changes a control gain of the pressure increase valve so as to accelerate the response of the pressure increase valve according to the length of the first voltage recovery time.

5. The brake control apparatus according to claim 4, wherein the gain changing portion increases the control gain of the pressure increase valve the longer the first voltage recovery time.

6. The brake control apparatus according to claim 2, further comprising:
a stroke simulator that creates a reaction force of the brake pedal;
a third communication path that connects the stroke simulator with the master cylinder; and
a simulator cutoff valve provided in the third communication path and which is operated by the valve control portion, wherein
the voltage measuring portion estimates a second voltage recovery time that it takes for the voltage of the power supply to recover to a second predetermined level from a temporary drop due to operation of the master cutoff valve and the pressure increase valve; and
the valve control portion stops operating the simulator cutoff valve when the second voltage recovery time is equal to or greater than a predetermined threshold value.

7. A brake control method comprising the steps of:
supplying operating fluid with a master cylinder in response to an operation of a brake pedal;
storing high pressure operating fluid with an accumulator;
operating a wheel cylinder using the operating fluid supplied from the master cylinder or the accumulator so as to operate a brake provided at each wheel of a vehicle; and
controlling the supply of power from a power supply so as to offset the timings at which a master cutoff valve provided midway in a communication path between the master cylinder and the wheel cylinder and a pressure increase valve provided midway in a communication path between the accumulator and the wheel cylinder are operated.

8. The brake control method according to claim 7, further comprising the steps of:
measuring a first voltage recovery time that it takes for the voltage of the power supply to recover to a first predetermined level from a temporary drop due to operation of the master cutoff valve;
determining whether a brake request has been issued based on the operation of the brake pedal;
closing the master cutoff valve when it has been determined that the brake request has been issued; and
opening the pressure increase valve after the first voltage recovery time has passed after the master cutoff valve was closed.

9. The brake control method according to claim 8, further comprising the step of changing a control gain of the pressure increase valve so as to accelerate the response of the pressure increase valve according to the length of the first voltage recovery time.

10. The brake control method according to claim 9, further comprising the step of increasing the control gain of the pressure increase valve the longer the first voltage recovery time.

11. The brake control method according to claim 7, further comprising the steps of:
estimating a second voltage recovery time that it takes for the voltage of the power supply to recover to a second predetermined level from a temporary drop due to operation of the master cutoff valve and the pressure increase valve; and
stopping operation of a simulator cutoff valve provided in a communication path between a stroke simulator that creates a reaction force of the brake pedal and the master cylinder when the second voltage recovery time is equal to or greater than a predetermined threshold value.
